(19) United States
(12) Patent Application Publication
(10) Pub. No.: US 2003/0005771 A1
(43) Pub. Date: Jan. 9, 2003

(54) Two-dimensional array of ultrasonic sensors for high throughput fluid screening

(76) Inventors: Gokhan Percin, Palo Alto, CA (US); F. Levent Degertekin, Atlanta, GA (US); Butrus T. Khuri-Yakub, Palo Alto, CA (US)

Correspondence Address: LUMEN INTELLECTUAL PROPERTY SERVICES, 45 CABOT AVENUE, SUITE 110, SANTA CLARA, CA, 95051, US

(21) Appl. No.: 10/165,621

(22) Filed: Jun. 7, 2002

Related U.S. Application Data
(60) Provisional application No. 60/296,869, filed on Jun. 7, 2001.

(51) Int. Cl. G01N 29/04

(52) U.S. Cl. 73/627; 73/597

(57) ABSTRACT

A two-dimensional sensor array for high throughput screening of fluids in micro-machined fluid arrays is provided. The sensor array includes a two-dimensional array of piezoelectric transducers which are in contact with the back-side of the micro-machined fluid array which is opposite from the fluid positions. A means is provided to generate and detect shear or longitudinal ultrasonic waves in a time-multiplexed manner whereby the waves could propagate in either a pulse or continuous mode. A means to determine fluid parameters based on the shear and longitudinal ultrasonic waves is also provided. Furthermore, a fluid dispense system could be included which is then controlled based on the determined fluid parameters and a feedback control system. The two-dimensional micro-sensor array is compatible with and based on miniaturization technologies for high-throughput biology, such as micro-fluidics, detection, sample handling, and bioassay technology amenable to high-density formats.

### STATEMENT REGARDING FEDERALLY SPONSORED RESEARCH OR DEVELOPMENT

This invention was supported in part by the Defense Advanced Research Projects Agency (DARPA) of the Department of Defense (DoD) and was monitored by the Air Force Office of Scientific Research under grant number F49620-95-1-0525. The U.S. Government has certain rights in the invention.

### FIELD OF THE INVENTION

This invention relates generally to ultrasonic transducers. More particularly, the invention relates to ultrasonic transducers for high-throughput screening of fluids and catalyzing of (bio)-chemical reactions in fluids.

### BACKGROUND

Ultrasonic transducers are used to generate and detect acoustic waves in solid and fluid media. They are found in a wide variety of applications, including chemical sensing, signal processing, nondestructive evaluation, and medical imaging. During the last few years, the application of micro-fabrication techniques has entered the medical and biotechnological field and has initiated the development of powerful new diagnostic devices (See e.g. Voldman J, gray M L & Schmidt M A (1999) in a paper entitled “Microfabrication in biology and medicine” and published in Annular Review of Biomedical Engineering 1:401-425). For instance, micro-machined array devices are being used in high throughput screening or in the development of biochips such, as immunoassays or DNA diagnostic assays. These devices require, however, reliable and robust methods for dispensing very small samples of biological and chemical fluids. Therefore, the need arises to provide practical tools that have the potential to increase throughput and lower the cost of, for instance, combinatorial drug synthesis, screening and testing. However, one of the problems to overcome in high-throughput screening is the determination of dispensed fluid volume, the sensing of physical properties of the dispensed fluid mixture in a well, i.e. temperature, density, and viscosity, and the determination whether the dispense system actually ejected the required volume. In particular, measuring these parameters would be a challenge in case the fluid involves a chemical or biochemical process that is dynamically evolving. Previous methods related to ultrasonic photoresist process monitoring as taught by Khuri-Yakub et al. in U.S. Pat. Nos. 6,026,688 and 6,250,161 would not be sufficient. The method taught in U.S. Pat. Nos. 6,026,688 and 6,250,161 for monitoring the condition of a photoresist is well-defined since it is relates to a finite film which is continuous in both directions. The requirements for monitoring the photoresist would therefore be different compared to screening fluids or biological agents or structures. Furthermore, the method taught in U.S. Pat. Nos. 6,026,688 and 6,250,161 does not address the problems associated in high-throughput screening in case a large number of fluids needs to be screened in an efficient and low cost manner. It would therefore be desirable to have lower cost and reliable micro-sensor arrays that would be able to sense these various fluid parameters in high-throughput screening for biological samples and chemical processes. Furthermore, it would be desirable to develop micro-sensor arrays that would be compatible with micro-machined fluid arrays.

### SUMMARY OF THE INVENTION

The present invention provides a two-dimensional sensor array for high throughput screening of fluids in micro-machined fluid arrays. Examples of micro-machines fluid arrays are for example assay well micro-plates, micro-arrays, manufacturing of biochips such as immunoassays or DNA diagnostic assays, or any production line tool that has the potential or need to increase throughput and lower cost of combinatorial drug synthesis, screening and testing. The two-dimensional sensor array of the present invention includes a two-dimensional array of piezoelectric transducers which are in contact with the back-side of the micro-machined fluid array which is opposite from the fluid positions or wells. Furthermore each of the piezoelectric transducers in the array is arranged in line with each position of the fluids or wells. The two-dimensional sensor array of the present invention further includes a means to generate in each of the piezoelectric transducers shear or longitudinal ultrasonic waves that propagate through the piezoelectric transducer, the micro-machined fluid array and the fluid. The shear or longitudinal ultrasonic waves could be delivered in a pulsed mode for screening the fluids. The shear or longitudinal ultrasonic waves could also be delivered in a continuous mode for promoting a biochemical or chemical reaction in the fluids or mixing of the fluids. The means is further able to detect from each of the piezoelectric transducers the reflected shear or longitudinal ultrasonic waves from the micro-machined fluid array and the fluid. In order to avoid cross-talk between the ultrasonic waves generated in each piezoelectric transducer, it is important that the shear or longitudinal ultrasonic waves are generated in a time-multiplexed manner by having time delays for each of the piezoelectric transducers.

In the present invention, exemplary embodiments are shown that involve two-dimensional micro-sensor arrays, which could be directly attached to a micro-machined fluid array. The present invention also teaches embodiments of two-dimensional micro-sensor arrays that could be manufactured as a separate two-dimensional micro-sensor array from any type of fluid array. This would then enable a two-dimensional micro-sensor array that could be attached as well as detached from the fluid array so that it can be used for multiple screenings or testings and would not be disposed together with the fluid array device. One configuration of such a two-dimensional sensor array shows each of the piezoelectric transducers in combination with a buffer rod whereby the buffer rod is placed in between the micro-machined fluid array and each of the piezoelectric transducers. Each buffer rod includes a coupling film in between the buffer rod and the micro-machined fluid array. Another configuration of such a two-dimensional sensor array shows the piezoelectric transducers in combination with a passive carrier plate whereby the passive carrier plate is in between the two-dimensional array of piezoelectric transducers and the micro-machined fluid array. In this case the passive carrier plate includes a coupling film in between the passive carrier plate and the micro-machined fluid array. Furthermore, the passive carrier plate includes rounded tips that create contact between the passive carrier plate and the micro-machined fluid array and these tips are in line with each position of the fluids or wells.

The two-dimensional sensor array further includes means to determine parameters of the fluids whereby the determination of the parameters is based on the shear and longitudinal ultrasonic waves. Examples of parameters that could be determined are fluid volume, temperature, density, viscosity, fluid mixture, fluid level, sound velocity, acoustic impedance or existence of biological or chemical reactions. The two-dimensional sensor array could further include a fluid dispense system, whereby the fluid dispense system is controlled based on the determined parameters and a feedback control system.

In view of that which is stated above, it is the objective of the present invention to provide a two-dimensional micro-sensor array for high throughput screening of fluids.

It is still another objective of the present invention to propagate and detect shear and longitudinal ultrasonic waves using a two-dimensional micro-sensor array for high throughput screening of fluids.

It is still another objective of the present invention to generate and detect shear and longitudinal ultrasonic waves in a time-multiplexed manner.

It is still another objective of the present invention to provide two-dimensional micro-sensor array that includes buffer rods and coupling films.

It is still another objective of the present invention to provide two-dimensional micro-sensor array that includes a passive carrier plate with a coupling film.

It is still another objective of the present invention to use the two-dimensional micro-sensor array in combination with micro fluid arrays.

It is yet another objective of the present invention to determine fluid parameters based on shear and longitudinal ultrasonic waves.

It is yet another objective of the present invention to catalyze or mix fluids or agents using the ultrasonic waves generated by the two-dimensional micro-sensor array.

It is yet another objective of the present invention to control a fluid dispense system or device based on the determined fluid parameters.

The advantage of the present invention is that it provides a two-dimensional micro-sensor array compatible with and based on miniaturization technologies for high-throughput biology, such as micro-fluidics, detection, sample handling, and bioassay technology amenable to high-density formats. Another advantage of the present invention is that it improves accuracy and throughput of small fluid assaying and screening at a lower cost.

### BRIEF DESCRIPTION OF THE FIGURES

The objectives and advantages of the present invention will be understood by reading the following detailed description in conjunction with the drawings, in which:

FIG. 1 shows an exemplary embodiment of a two-dimensional micro-sensor array involving an assay well microplate according to the present invention;

FIG. 2 shows an exemplary embodiment of a two-dimensional micro-sensor array involving a micro biochip according to the present invention;

FIG. 3 shows an exemplary embodiment of a two-dimensional micro-sensor array with buffer rods and coupling films involving an assay well microplate according to the present invention;

FIG. 4 shows an exemplary embodiment of a two-dimensional micro-sensor array with buffer rods and coupling films involving a micro biochip according to the present invention;

FIG. 5 shows an exemplary embodiment of a two-dimensional micro-sensor array with a passive carrier plate involving an assay well microplate according to the present invention;

FIG. 6 shows an exemplary embodiment of a two-dimensional micro-sensor array with a passive carrier plate involving a micro biochip according to the present invention;

FIG. 7 shows an exemplary embodiment of propagating and reflected ultrasonic waves involving an exemplary assay well according to the present invention; and

FIG. 8 shows an exemplary embodiment of a two-dimensional micro-sensor array in combination with a dispense system according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The present invention provides a two-dimensional micro-sensor array. The two-dimensional sensor array is based on piezoelectric transducers that are placed in the two-dimensional micro-array. The two-dimensional micro-array could include several hundreds or thousands of piezoelectric transducers. The number of piezoelectric transducers in the two-dimensional micro-sensor array could, for instance, be related to the number of wells in an assay well micro-plate or the number of fluid recipient positions on a biochip. Furthermore, the number of piezoelectric transducers in the two-dimensional micro-sensor array could, for instance, also be related to the number of dispense units in a dispensing system that could be operating in conjunction with the micro-machined fluid array.

The two-dimensional micro-sensor array of the present invention could be used in applications involving high throughput screening in assay well micro-plates, micro-arrays, manufacturing of biochips such as immunoassays or DNA diagnostic assays, or any production line tool that has the potential or need to increase throughput and lower cost of combinatorial drug synthesis, screening and testing. However, the present invention is not limited to these applications and could include any type of screening or testing of fluids that operate at a micro-level with a large number of small sample sizes of fluids. Examples of fluids that could be screened are, for instance, chemical or biological samples for biotechnological or tissue engineering applications including accurate DNA sequencing of complex genomes, single nucleotide polymorphism (SNP) and haplotype analysis.

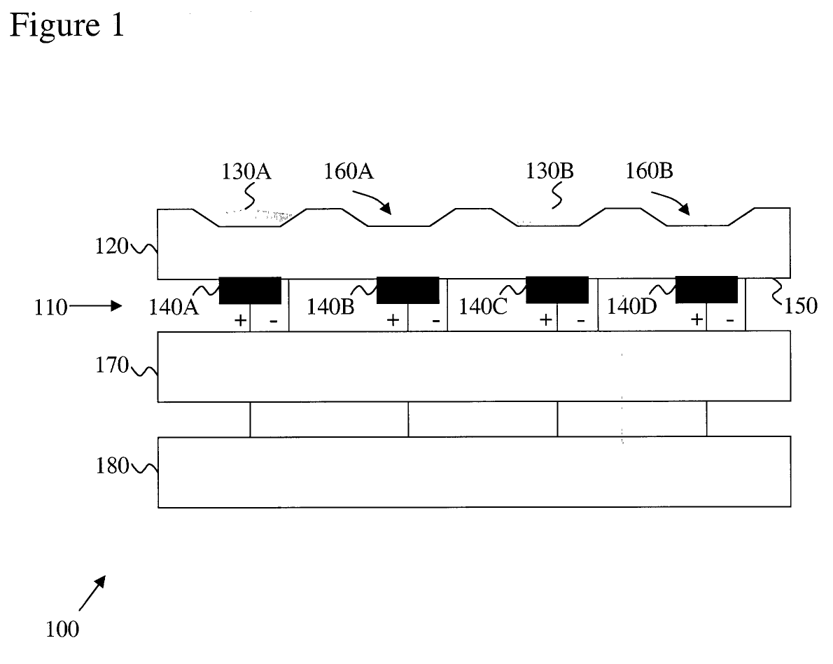

FIG. 1 shows an exemplary embodiment 100 with the two-dimensional micro-sensor array 110 of the present invention involving an assay well microplate 120 for high throughput screening of fluids such as exemplary fluids 130A-B. Two-dimensional micro-sensor array 120 shows only four sensors, but as a person of average skill in the art would readily appreciate, two-dimensional micro-sensor array 120 could include any number of sensors either arranged in a linear array, square array or rectangular array. Two-dimensional micro-sensor array 120 includes piezoelectric transducers 140A-D, which are in contact with the back-side 150 of assay well micro plate 110. At the top-side of assay well microplate 110, fluids 130A-B are present in the wells of assay well micro plate 110. For illustrative purposes, wells 160A-B have not been filled with a fluid yet, but are ready to filled using, for instance, a dispenser device or system. Piezoelectric transducers 140A-D in two-dimensional micro-sensor array 120 are arranged in such a way that each piezoelectric transducer corresponds with the position of each well in the assay well micro plate 110. The two-dimensional micro-sensor array of the present invention further includes a means 170 to generate in each of the piezoelectric transducer shear or longitudinal ultrasonic waves. The shear or longitudinal ultrasonic waves propagate through the piezoelectric transducer, the assay well micro plate 110, and the fluids 130A-B and/or wells 160A-B. Means 170 is also able to receive the reflected shear or longitudinal ultrasonic waves that are detected in each of piezoelectric transducer. The reflected shear or longitudinal ultrasonic waves originate from the assay well micro plate 110, fluids 130A-B and/or wells 160A-B.

Each piezoelectric transducer in the two-dimensional micro-sensor array of the present invention is capable of generating and detecting shear or longitudinal ultrasonic waves. Furthermore, in order to avoid cross-talk among the ultrasonic waves generated in each piezoelectric transducer with other ultrasonic waves generated by other piezoelectric transducers in the two-dimensional micro-sensor array, means 170 generates and receives the ultrasonic waves in a time-multiplexed manner. Time multiplexing could, for instance, be accomplished by having time delays for each of piezoelectric transducers. The frequency at which these ultrasonic waves should be generated is at least 20 Mhz and is controlled by means 170. Means 170 also controls the voltage that needs to be applied to each of the piezoelectric transducers, which could range from about 10V to about 100V. It is important that the voltage is high enough to generate reflected pulses, but not too high that it would burn one of the sensor elements in the two-dimensional micro-sensor array or (biological) agents in the fluid. Means 170 also controls the mode in which the ultrasonic waves are generated which could be a pulse mode, a sinusoidal mode or a square mode. In case means 170 generates the shear or longitudinal ultrasonic waves in a pulsed mode, then the two-dimensional micro-sensor array of the present invention is used for screening of the fluids. However, in case means 170 generates shear or longitudinal ultrasonic waves in a continuous mode, then the two-dimensional micro-sensor array of the present invention is used for promoting a biochemical or chemical reaction in the fluids or mixing of the fluids. Means 170 is therefore able to switch between any mode such as switching between pulse mode and continuous mode. It would also be possible to have means 170 increase or decrease the power to decrease or increase the degree of mixing.

The exemplary embodiment of FIG. 1 involves a two-dimensional micro-sensor array 120 in combination with an assay well microplate 110. However, the present invention of a two-dimensional micro-sensor array could in general involve a two-dimensional micro-sensor array that is used in combination with a micro-machined fluid array such as, but not limited to, an assay well microplate, a biochip, a micro-array, a lab-on-chip system or the like.

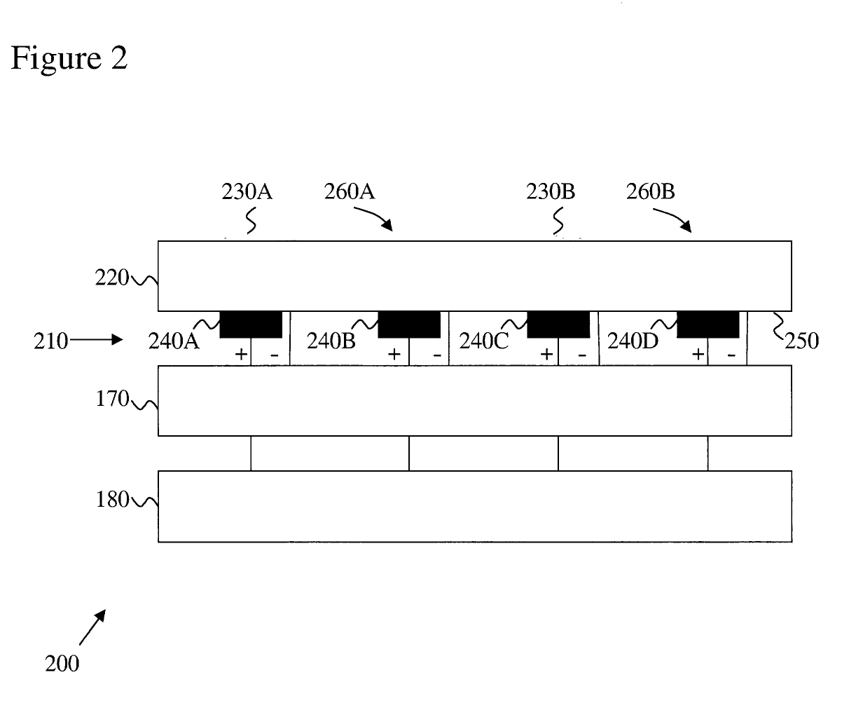

FIG. 2 shows an exemplary embodiment 200 with the two-dimensional micro-sensor array 210 of the present invention involving a micro-biochip 220 for high throughput screening of fluids such as exemplary fluids 230A-B. Two-dimensional micro-sensor array 210 includes piezoelectric transducers 240A-D, which are in contact with the back-side 250 of micro-biochip 220. At the top-side of micro-biochip 220, fluids 230A-B are present in positions on micro-biochip 220. For illustrative purpose, positions 260A-B have not yet been covered with a fluid, but a dispenser system could do so at a later time instant Piezoelectric transducers 240A-D in two-dimensional micro-sensor array 210 are arranged in such a way that each piezoelectric transducer corresponds with the position or the (possible) position of each fluid drop on micro-biochip 220.

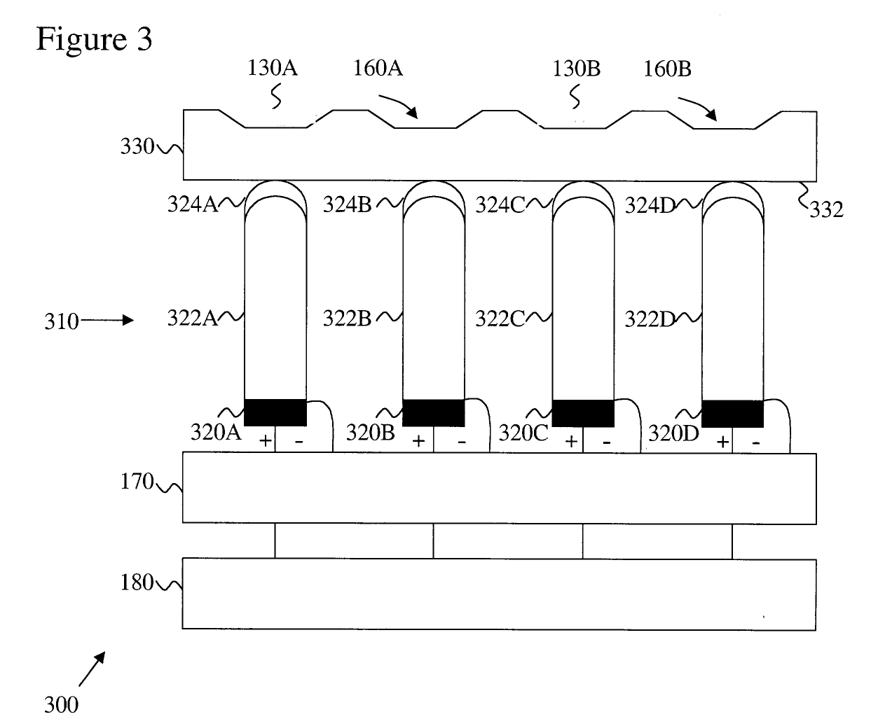

The exemplary embodiments as shown in FIGS. 1-2 involve two-dimensional micro-sensor arrays, which could be directly attached to a micro-machined fluid array such as shown for assay well microplate 120 or micro-biochip 220, respectively. FIGS. 3-6 shows embodiments of the present invention of two-dimensional micro-sensor array that could be manufactured as a separate two-dimensional micro-sensor array from any type of fluid array. This would then allow a two-dimensional micro-sensor array that could be attached as well as detached from the fluid array so that it can be used for multiple screenings or testings and would not be disposed together with the fluid array device.

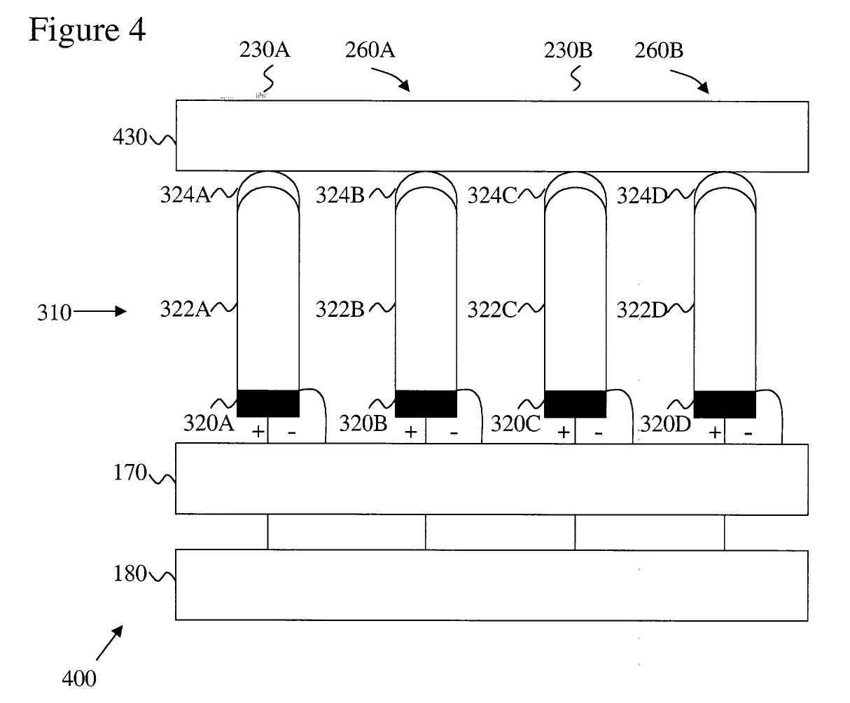

FIG. 3 shows a similar two-dimensional micro-sensor array as shown in FIG. 1 with the difference that each piezoelectric transducer 320A-D in two-dimensional micro-sensor array 310 includes a buffer rod 322A-D respectively. Buffer rod 322A-D is placed in between the assay well microplate 330 and each of piezoelectric transducer 320A-D respectively and couples the ultrasonic waves from each of the piezoelectric transducers to assay well microplate 330. Buffer rod 322A-D has preferably a rounded top that enables a good contact with the back side 332 of assay well microplate 330. Buffer rod 322A-D could be made of materials such as, but not limited to, quartz, lithium niobate, or other solid materials that allow shear and longitudinal ultrasonic waves to propagate with relatively small attenuation. Furthermore, buffer rod 322A-D includes a coupling film 324A-D that further enhances the coupling of the ultrasonic waves from buffer rod 322A-D to assay well microplate 330. Coupling film 324A-D is placed on top of buffer rod 322A-D and touches micro-machined fluid array 330. Coupling film is permanently attached to the buffer rod by micro-machining techniques as they are well-known in the art. Coupling film 324A-D is preferably less than 25 μm thick to allow the ultrasonic waves to pass through and could, for instance, but not limited to, be a polyimide film (Kapton®), a PMMA (Poly(methyl methacrylate)), a Parylene or PDMS (polydimethylsiloxane). In order to obtain good and sufficient contact between buffer rod 322A-D including coupling film 324A-D with assay well microplate 330, a spring-loaded mechanism (not shown) could be used, as a person of average skill in the art would readily appreciate. FIG. 4 shows a similar two-dimensional micro-sensor array as shown in FIG. 3 with the difference that the embodiment 300 in FIG. 3 shows an assay well microplate 330, whereas embodiment 400 in FIG. 4 shows a micro-biochip 430.

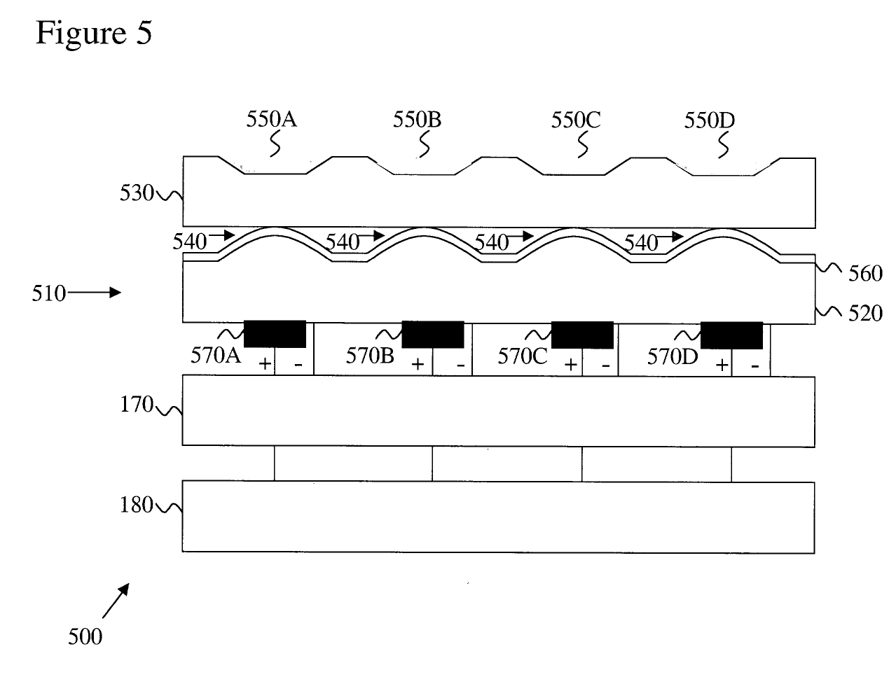

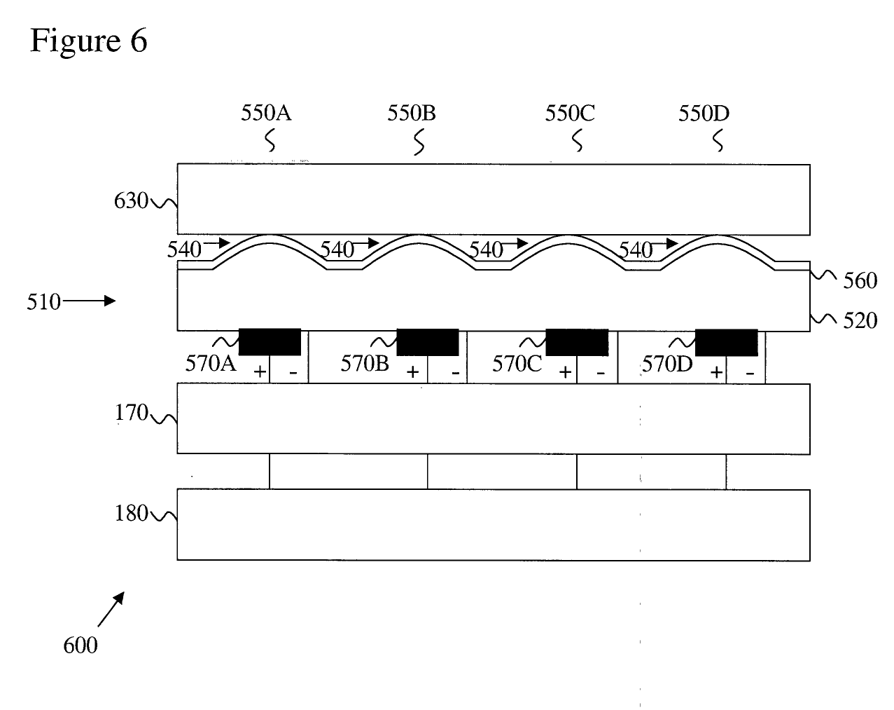

FIG. 5 shows another configuration 500 of two-dimensional micro-sensor array 510. Two-dimensional micro-sensor array 510 now includes a passive carrier plate 520 with preferably rounded or circular tips 512 that create contact between passive carrier plate 520 and assay well microplate 530. Tips 540 are positioned or arranged in line with each position of fluids 550A-D in the wells of assay well microplate 530. Furthermore, a coupling film 560 is placed, using micro-machining techniques known in the art, over passive carrier plate 520. At the bottom of the passive carrier plate 520, piezoelectric transducers 570A-D are positioned and arranged in an array. The position and arrangement of piezoelectric transducers 570A-D corresponds to tips 540 of passive carrier plate 520 and in line with the well of assay well microplate 530. Passive carrier plate 520 could be made of a material such as, but not limited to, quartz, lithium niobate, or other solid materials that allow shear and longitudinal ultrasonic waves to propagate with relatively small attenuation. In addition, it would be possible to use z-cut Quartz as a longitudinal mode transducer and AT-cut Quartz as a shear mode transducer. FIG. 6 shows a similar two-dimensional micro-sensor array as shown in FIG. 5 with the difference that the embodiment 500 in FIG. 5 shows assay well microplate 530, whereas embodiment 600 in FIG. 6 shows a micro-biochip 630.

The two-dimensional micro-sensor array of the present invention further includes means to determine 180 parameters of the fluids based on the shear and longitudinal ultrasonic waves as the piezoelectric transducers have detected them. The reflected ultrasonic waves could either be directly received by means 180 to determine parameters of the fluids or transmitted through means 170. How this would be accomplished basically depends on the physical set-up of the different elements or components that are part of the two-dimensional micro-sensor array. Means 180 to determine parameters of the fluids, however, is preferably a computer-like device or instrument (which are known in the art) that is capable of interpreting and calculating parameters of the fluids. This would also be preferably done in a real-time manner. Examples of parameters that could be calculated given the reflected shear and longitudinal ultrasonic waves are, for instance, but not limited to, fluid volume, temperature, density, viscosity, fluid mixture, fluid level, sound velocity, acoustic impedance or existence of biological or chemical reactions.

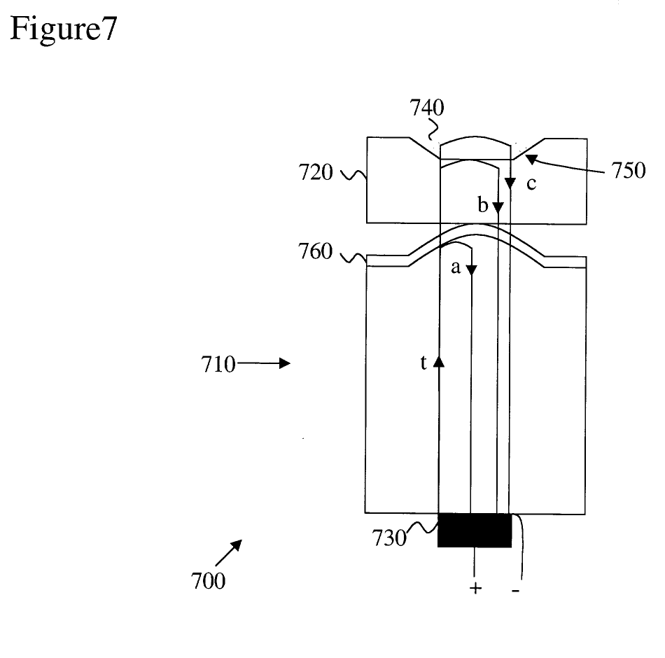

FIG. 7 shows an example of a part of a two-dimensional micro-sensor array 710 combined with a part of a single well 720 of an assay well microplate to illustrate the propagating t and reflected a, b and c ultrasonic waves generated by piezoelectric transducer 730 to respectively fluid 740, well 750 and coupling film 760. Temperature of the well 750 and the viscosity of the fluid mixture in well 750 can be obtained from the shear and longitudinal ultrasonic waves b and a. The density of fluid 740, the temperature of fluid 740 and the fluid 740 level can be obtained from the reflected longitudinal waves c, b and a. As a person of average skill in the art would readily appreciate, multiple frequency measurements can be used to increase the accuracy of the measurements.

Examples of equations to calculate the parameters can be obtained from the teachings in, for instance, U.S. Pat. Nos. 6,026,688 and 6,250,161 to Khuri-Yakub et al. as well as by the teaching in a paper by Morton S L, Degertekin F L and Khuri-Yakub B T (1999) entitled “Ultrasonic sensor for photoresits process monitoring” and published in IEEE Transactions on Semiconductor Manufacturing 12(3):332-339. However, the major difference between the equations taught in these U.S. Patents and by Morton et al. is that their calculations solely take into account the longitudinal ultrasonic waves, whereas the calculations in the present invention take into account both the shear and longitudinal waves.

The reflection coefficient for a longitudinal plane wave incident on a layer separating two semi-infinite media can be calculated using classical reflection theory (See for instance Kinsler L E, Frey A R, Coppens A B & Sanders J V in a book entitled “Fundamentals of Acoustics”, 3^{rd} Ed. Wiley, New York 1982) according to:

$$R = [ \frac{( 1 - \frac{{z}_{1}}{{z}_{3}} ) cos {k}_{2} L + j \frac{{z}_{2}}{{z}_{3}} sin {k}_{2} L}{( 1 + \frac{{z}_{1}}{{z}_{3}} ) cos {k}_{2} L + j \frac{{z}_{2}}{{z}_{3}} sin {k}_{2} L} ] \qquad [ 1 ]$$

where k₁ is the wave number and Z₁ is the acoustic impedance defined as:

$${k}_{i} = \frac{2 π f}{{c}_{i}} , whereby {z}_{i} = {ρ}_{i} {c}_{i} \qquad [ 2 ]$$

where the subscripts i=1,2,3 represent the media of substrate (i.e. biochip or assay plate) fluid (spot or fluid in well) and air, c, denotes the velocity of longitudinal waves in the medium and fᵢ is the density. The fluid (spot or fluid in well) thickness is represented by L and the frequency is given by f₁. A phase change in the reflected signal is also expected as the substrate changes temperature as shown by the following Equation:

$$Δ ϑ ( T ) = 4 π f d [ \frac{1}{v ( {T}_{0} ) [ 1 - {k}_{v} ( T - {T}_{0} ) ]} - \frac{1}{v ( {T}_{0} )} ] \qquad [ 3 ]$$

where d is the substrate (biochip, assay plate) thickness, θ(T) is the velocity of a longitudinal wave in the substrate at temperature T, T₀ is the ambient temperature and kᵥ is the temperature sensitivity of the longitudinal wave in the substrate. Equation 1 is also valid for shear waves. Equation 2 becomes as follows:

$$η = \frac{{( {z}_{2} )}^{2}}{{ρ}_{2} 2 π f} \qquad [ 4 ]$$

where η is the viscosity of the fluid, k₁ and z₁ values are calculated from the shear waves.

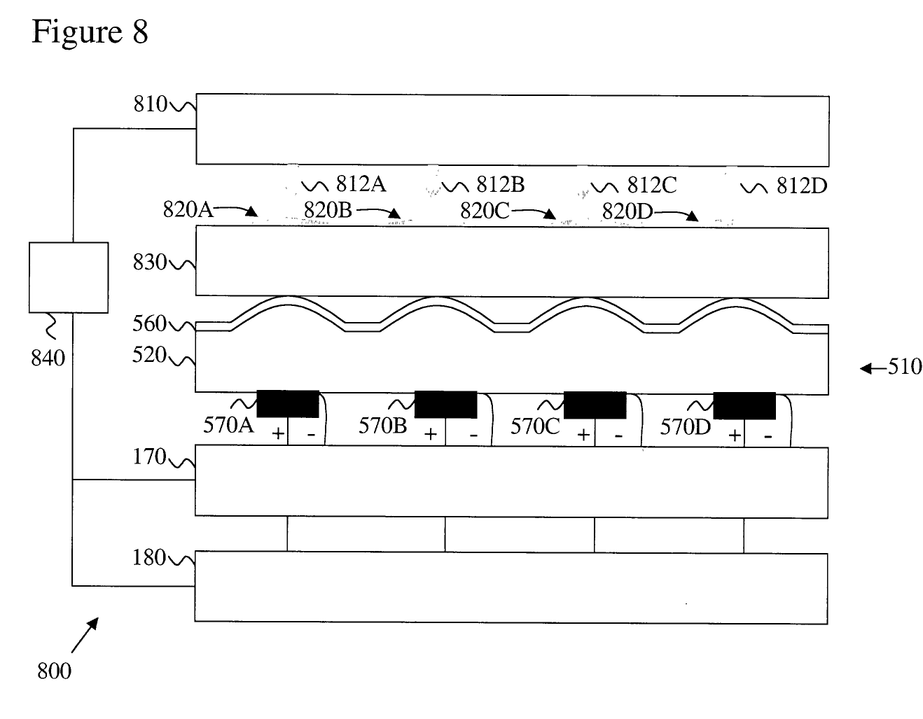

The two-dimensional micro-sensor array of the present invention could further include a fluid dispense system 810 as shown in exemplary embodiment 800 in FIG. 8. Dispense system 810 could dispense fluids 820A-D to, for instance, a biochip 830 using individual dispense heads 812A-D respectively. Dispense system 810 could also dispense fluid mixtures to biochip 830 whereby the mixture is established by adding different fluids or agents in a sequential manner to biochip 830 to fabricate a particular biological or chemical agent, compound or genetic structure. The fabrication of these mixtures and the timing of adding new fluids, agents or structures to the fluid mixture could be sensitive or a function of one or more of the particular fluid parameters and would therefore need to be monitored closely and accurately. The two-dimensional micro-sensor array would enable such a close monitoring of the fluid parameters in real-time, whereby dispense system 810 could be controlled based on the determined parameters and a feedback control system 840. Feedback control 840 enables the control of individual dispense heads 812A-D to dispense the next required addition to fluids 820A-D.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed is:

1. A two-dimensional sensor array for high throughput screening of fluids in micro-machined fluid arrays, comprising:
(a) a two-dimensional array of piezoelectric transducers in contact with the back-side of said micro-machined fluid array, wherein said back-side is opposite from said fluids and wherein each of said piezoelectric transducers are in line with each position of said fluids on said micro-machined fluid array; and
(b) a means to generate in each of said piezoelectric transducers shear or longitudinal ultrasonic waves that propagate through said piezoelectric transducer, said micro-machined fluid array and said fluid and wherein said means is able to detect in each of said piezoelectric transducers the reflected shear or longitudinal ultrasonic waves from said micro-machined fluid array and said fluid.

2. The two-dimensional sensor array as set forth in claim 1, wherein said shear or longitudinal ultrasonic waves are generated in said piezoelectric transducers in a time-multiplexed manner by having time delays for each said piezoelectric transducer.

3. The two-dimensional sensor array as set forth in claim 1, wherein said micro-machined fluid array is an assay well microplate, a biochip, a micro-array or a lab-on-chip system.

4. The two-dimensional sensor array as set forth in claim 1, wherein each of said piezoelectric transducers comprises a buffer rod and said buffer rod is placed in between said micro-machined fluid array and each of said piezoelectric transducers.

5. The two-dimensional sensor array as set forth in claim 4, wherein said buffer rod comprises a coupling film in between said buffer rod and said micro-machined fluid array.

6. The two-dimensional sensor array as set forth in claim 1, wherein said two-dimensional array of piezoelectric transducers comprises a passive carrier plate and said passive carrier plate is in between said two-dimensional array of piezoelectric transducers and said micro-machined fluid array, wherein said passive carrier plate comprises a coupling film in between said passive carrier plate and said micro-machined fluid array, and wherein said passive carrier plate comprises tips that create contact between said passive carrier plate and said micro-machined fluid array wherein said tips are in line with each position of said fluids on said micro-machined fluid array.

7. The two-dimensional sensor array as set forth in claim 6, wherein said passive carrier plate is made of a material selected from the group consisting of quartz, lithium niobate, or other solid materials that allow shear and longitudinal ultrasonic waves to propagate with relatively small attenuation.

8. The two-dimensional sensor array as set forth in claim 1, wherein said shear or longitudinal ultrasonic waves are generated in a pulsed mode or a continuous mode.

9. The two-dimensional sensor array as set forth in claim 1, further comprising means to determine parameters of said fluids based on said shear and longitudinal ultrasonic waves.

10. The two-dimensional sensor array as set forth in claim 9, wherein said parameters are fluid volume, temperature, density, viscosity, fluid mixture, fluid level, sound velocity, acoustic impedance or existence of biological or chemical reactions.

11. The two-dimensional sensor array as set forth in claim 9, further comprising a fluid dispense system wherein said fluid dispense system is controlled based on said determined parameters and feedback control.

12. A method for high throughput screening of fluids in a micro-machined fluid array with a two-dimensional sensor array, comprising the steps of:
(a) providing a two-dimensional array of piezoelectric transducers in contact with the back side of said micro-machined fluid array, wherein said back side is opposite from said fluids and wherein each of said piezoelectric transducers are in line with each position of said fluids on said micro-machined fluid array; and
(b) providing a means to generate in said piezoelectric transducers shear or longitudinal ultrasonic waves that propagate through said piezoelectric transducer, said micro-machined fluid array and said fluid and wherein said means is able to detect in each of said piezoelectric transducers the reflected shear or longitudinal ultrasonic waves from said micro-machined fluid array and said fluid.

13. The method as set forth in claim 12, further comprising means to generate said shear or longitudinal ultrasonic waves in a time-multiplexed manner by having time delays for each said piezoelectric transducer.

14. The method as set forth in claim 12, wherein said fluid array is an assay well microplate, a biochip, a micro-array or a lab-on-chip system.

15. The method as set forth in claim 12, wherein each of said piezoelectric transducers comprises a buffer rod and said buffer rod is placed in between said micro-machined fluid array and each of said piezoelectric transducers.

16. The method as set forth in claim 15, wherein said buffer rod comprises a coupling film in between said buffer rod and said micro-machined fluid array.

17. The method as set forth in claim 12, wherein said two-dimensional array of piezoelectric transducers comprises a passive carrier plate and said passive carrier plate is in between said two-dimensional array of piezoelectric transducers and said micro-machined fluid array, wherein said passive carrier plate comprises a coupling film in between said passive carrier plate and said micro-machined fluid array, and wherein said passive carrier plate comprises tips that create contact between said passive carrier plate and said micro-machined fluid array wherein said tips are in line with each position of said fluids on said micro-machined fluid array.

18. The method as set forth in claim 17, wherein said passive carrier plate is made of a material selected from the group consisting of quartz, lithium niobate, or other solid materials that allow shear and longitudinal ultrasonic waves to propagate with relatively small attenuation.

19. The method as set forth in claim 12, further comprising means to generate said shear or longitudinal ultrasonic waves in a pulsed mode for screening said fluids.

20. The method as set forth in claim 12, further comprising means to generate said shear or longitudinal ultrasonic waves in a continuous mode for promoting a biochemical or chemical reaction in said fluids or mixing of said fluids.

21. The method as set forth in claim 12, further comprising means to determine parameters of said fluids based on said shear and longitudinal ultrasonic waves.

22. The method as set forth in claim 21, wherein said parameters are fluid volume, temperature, density, viscosity, fluid mixture, fluid level, sound velocity, acoustic impedance or existence of biological or chemical reactions.

23. The method as set forth in claim 21, further comprising the step of providing a fluid dispense system wherein said fluid dispense system is controlled based on said determined parameters and feedback control.
